(19) United States
(12) Patent Application Publication
(10) Pub. No.: US 2023/0247510 A1
(43) Pub. Date: Aug. 3, 2023

(54) COMMUNICATION CONTROL APPARATUS AND IDENTIFIER DETERMINATION METHOD

(71) Applicant: Fujitsu Limited, Kawasaki-shi (JP)

(72) Inventors: Takaharu Kobayashi, Yamato (JP); MASAYUKI ONO, Kawasaki (JP)

(73) Assignee: Fujitsu Limited, Kawasaki-shi (JP)

(21) Appl. No.: 17/959,700

(22) Filed: Oct. 4, 2022

(30) Foreign Application Priority Data
Jan. 28, 2022 (JP) 2022-012354

(51) Int. Cl. H04W 36/30; H04W 72/08; H04W 36/36

(52) U.S. Cl. CPC H04W 36/30; H04W 72/087; H04W 36/36

(57) ABSTRACT

A communication control apparatus includes a memory, and a processor coupled to the memory. The processor is configured to determine, by using metrics related to a first value and a second value, first remainders of divisions of a cell identifier respectively by the first value and the second value, determine a second remainder of a division of the cell identifier by the least common multiple of the first value and second value, by using the first remainders, determine a third remainder of a division of the cell identifier by the least common multiple of the first value, the second value, and a third value, by using the second remainder and a metric related to the third value, and determine a cell identifier that satisfies the third remainder.

### CROSS-REFERENCE TO RELATED APPLICATIONS

This application is based upon and claims the benefit of priority of the prior Japanese Patent Application No. 2022-012354, filed on Jan. 28, 2022, the entire contents of which are incorporated herein by reference.

### FIELD

The embodiments discussed herein are related to communication control apparatuses and identifier determination methods.

### BACKGROUND

Identifiers for respectively identifying cells forming a wireless communication system are generally assigned to these cells. Examples of such cell identifiers include physical cell IDs (PCIs). For example, the fifth generation mobile communication system (5G) has 1008 kinds of PCIs assigned respectively to cells. These PCIs are combinations of three kinds of primary synchronization signals (PSSs) and 336 kinds of secondary synchronization signals (SSSs).

PCIs are identifiers for respectively identifying plural cells, and PCIs of adjacent cells are thus desirably different from each other, for example. Furthermore, when the remainders of divisions of PCIs of adjacent cells by 3 are the same, for example, these cells have the same PSS and accuracy of channel estimation is thus reduced and synchronization is delayed. Therefore, the remainders of divisions of PCIs of adjacent cells by 3 are desirably different from each other. In addition, PCIs are sometimes set according to plural indices, for example, on the basis of the fact that the remainders of divisions of PCIs of adjacent cells by 4 are desirably different from each other so that subcarrier positions of demodulation reference signals (DMRSs) of their physical broadcast channels (PBCHs) do not overlap each other.
Patent Literature 1: Japanese Laid-open Patent Publication No. 2020-167464
Patent Literature 2: Japanese National Publication of International Patent Application No. 2018-509858
Patent Literature 3: Japanese National Publication of International Patent Application No. 2020-504991
Non-Patent Literature 1: Techplayon, “5G NR Physical Cell ID (PCI) Planning”, [online], Nov. 18, 2019, URL: https://www.techplayon.com/5g-nr-physical-cell-id-pci-planning/

### SUMMARY

According to an aspect of an embodiment, a communication control apparatus includes a memory; and a processor coupled to the memory. The processor is configured to determine, by using metrics related to a first value and a second value, first remainders of divisions of a cell identifier respectively by the first value and the second value, determine a second remainder of a division of the cell identifier by the least common multiple of the first value and second value, by using the first remainders, determine a third remainder of a division of the cell identifier by the least common multiple of the first value, the second value, and a third value, by using the second remainder and a metric related to the third value, and determine a cell identifier that satisfies the third remainder.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a configuration of a communication system;

FIG. 2 is a block diagram illustrating a configuration of a communication control apparatus according to a first embodiment;

FIG. 3 is a sequence diagram illustrating a cell identifier initial setting method;

FIG. 4 is a flow diagram illustrating cell identifier initial setting processing;

FIG. 5 is a block diagram illustrating a configuration of a communication control apparatus according to a second embodiment;

FIG. 6 is a sequence diagram illustrating a cell identifier optimization method;

FIG. 7 is a flow diagram illustrating cell identifier optimization processing; and

FIG. 8 is a diagram illustrating a specific example of the numbers of HOs between cells with the same remainders.

### DESCRIPTION OF EMBODIMENTS

However, substantial effort is needed for setting of the PCI when a cell is newly established, for example. That is, as described above, the PCI of a cell is sometimes set according to plural indices, and determining the PCI in consideration of these indices manually increases the time and cost needed for setting of the PCI. Determining the PCI of a cell automatically, which one may think of in view of this problem, is not easy because no information is available on the wireless quality of a cell that is newly established, for example, and there is thus not much information serving as the basis of the determination. Furthermore, when plural indices are considered with respect to the remainders related to PCIs of adjacent cells, automatically setting the optimum PCIs according to these indices is difficult.

Preferred embodiments will be explained with reference to accompanying drawings. These embodiments do not limit the present disclosure.

### [a] First Embodiment

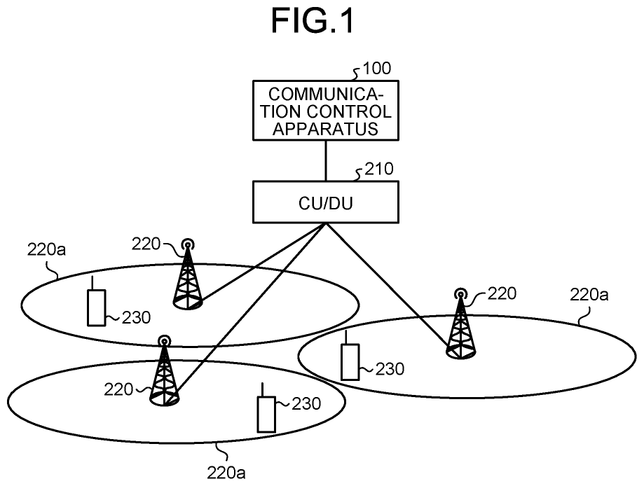

FIG. 1 is a diagram illustrating an example of a configuration of a communication system according to a first embodiment. The communication system illustrated in FIG. 1 has a communication control apparatus 100, a central unit/distributed unit (CU/DU) 210, radio units (RUs) 220, and pieces of user equipment (UE) 230.

The communication control apparatus 100 is called, for example, an RAN intelligent controller (RIC) and controls the CU/DU 210 that is a base station of a wireless communication system. Specifically, the communication control apparatus 100 determines PCIs that are cell identifiers of cells 220a subordinate to the CU/DU 210 and assigns the PCIs to these cells 220a. On the basis of indices that are the remainders of divisions of PCIs of adjacent cells 220a by three values that are different from one another, the communication control apparatus 100 determines a PCI of a cell 220a. That is, the communication control apparatus 100 determines the PCI of the cell 220a so that the remainders of divisions of the PCIs of adjacent cells 220a by a first value (for example, 3), the remainders of divisions of these PCIs by a second value (for example, 4), and the remainders of divisions of these PCIs by a third value (for example, 30) each do not become the same wherever possible. The communication control apparatus 100 is thus capable of automatically setting optimum cell identifiers in consideration of plural indices. A configuration and operation of the communication control apparatus 100 will be described in detail later.

According to the description of this first embodiment, three indices are used as the plural indices for determination of a PCI of a cell 220a, the three indices being the remainders of divisions of PCIs by 3, the remainders of divisions of the PCIs by 4, and the remainders of divisions of the PCIs by 30. That is, the remainders of the divisions of the PCIs by 3, 4, and 30 are desirably not the same between adjacent cells wherever possible. Making the remainders of the divisions of the PCIs by 3 different between the adjacent cells enables PSSs of the adjacent cells to be different from each other and enables minimization of: reduction in accuracy of channel estimation; and delay in synchronization. Furthermore, making the remainders of the divisions of the PCIs by 4 different between the adjacent cells prevents overlap between subcarrier positions of DMRSs of their PBCHs and enables reduction of interference. In addition, making the remainders of the divisions of the PCIs by 30 different between the adjacent cells enables bases of Zadoff-Chu (ZC) sequences to be different from each other and enables reduction of interference, the ZC sequences being used in DMRSs and sounding reference signals (SRSs) in their physical uplink control channels (PUCCHs) and physical uplink shared channels (PUSCHs).

The CU/DU 210 is a baseband device forming the base station of the wireless communication system. The CU/DU 210 is connected to a core network not illustrated in the drawings and executes baseband processing for data. Furthermore, the CU/DU 210 is connected to the plural RUs 220 via fronthaul (FH) lines and manages information related to the cells 220a formed by the RUs 220. Specifically, the CU/DU 210 sets, for the cells 220a, cell identifiers that the CU/DU 210 is notified of by the communication control apparatus 100. The CU/DU 210 controls transmission power in the cells 220a by controlling the RUs 220, and transmits and receives data to and from the pieces of UE 230 via the RUs 220.

The RUs 220 are wireless devices forming the base station of the wireless communication system. The RUs 220 execute wireless processing of data, form the cells 220a, and wirelessly transmit and receive data to and from the pieces of UE 230 within their cells 220a.

The pieces of UE 230 are terminal devices capable of wireless communication. The pieces of UE 230 each execute wireless communication with the RU 220 forming the cell 220a that the piece of UE 230 is in.

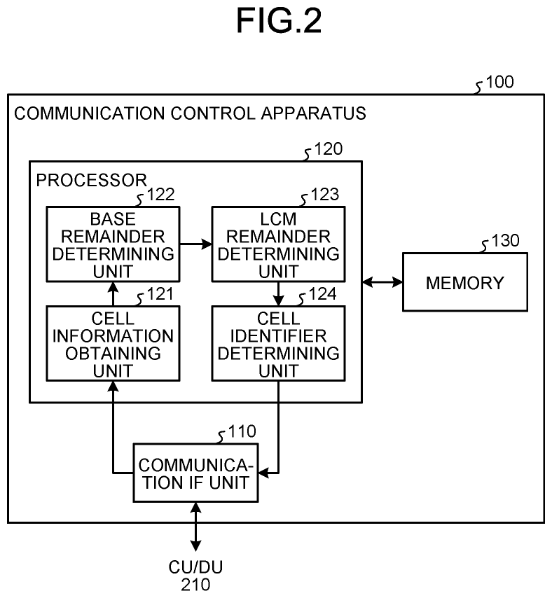

FIG. 2 is a block diagram illustrating the configuration of the communication control apparatus 100 according to the first embodiment. The communication control apparatus 100 illustrated in FIG. 2 has a communication interface unit (hereinafter, abbreviated as the “communication IF unit”) 110, a processor 120, and a memory 130.

The communication IF unit 110 is connected to the CU/DU 210, receives information from the CU/DU 210, and transmits information to the CU/DU 210. Specifically, the communication IF unit 110 receives cell information related to the cells 220a subordinate to the CU/DU 210. The cell information includes positional information on the RUs 220 forming the cells 220a and transmission power information on the RUs 220 in the cells 220a. Furthermore, the communication IF unit 110 transmits cell identifier information on the cells 220a to the CU/DU 210. This cell identifier information is determined by the processor 120.

The processor 120 includes, for example, a central processing unit (CPU), a field programmable gate array (FPGA), or a digital signal processor (DSP), and integrally controls the whole communication control apparatus 100. Specifically, the processor 120 has a cell information obtaining unit 121, a base remainder determining unit 122, a least common multiple (LCM) remainder determining unit 123, and a cell identifier determining unit 124.

The cell information obtaining unit 121 obtains the cell information related to the cells 220a, from the communication IF unit 110. That is, the cell information obtaining unit 121 obtains the cell information including the positional information on the RUs 220 forming the cells 220a and the transmission power information on the RUs 220 in the cells 220a.

The base remainder determining unit 122 calculates metrics related to remainders obtained by remainder calculation using the first value (3, herein) and the second value (4, herein), the remainders serving as indices for determination of a cell identifier, and determines remainders (hereinafter, referred to as the “base remainders”) that are respectively related to the first value and the second value and that minimize the metrics. Specifically, the base remainder determining unit 122 calculates, by Equation (1) below, a metric wₘ(i,k) for each remainder k obtained by remainder calculation using a value m, in determining a cell identifier of a cell #i.

$$\begin{matrix}[ 1 ] & \\ {w}_{m} ( i , k ) = {\sum }_{{j ∈ {C}_{update}}_{{PCI}_{j} \% m = k}} ( \frac{{P}_{i} + {P}_{j}}{2} ) {( \frac{1}{{d}_{i , j}} )}^{θ} + {\sum }_{{j ∈ {C}_{outside}}_{{PCI}_{j} \% m = k}} ( \frac{{P}_{i} + {P}_{j}}{2} ) {( \frac{1}{{d}_{i , j}} )}^{θ} & ( 1 )\end{matrix}$$

In Equation (1) above, C_{update} represents a set of cells 220a in a target range for which cell identifiers are to be set, and C_{outside} represents a set of cells where handover to and from the cells 220a in the set C_{update} is able to be carried out by a piece of UE 230. Furthermore, PCIⱼ is a cell identifier of a cell #j and % is an operation symbol representing remainder calculation. Therefore, PCIⱼ% m=k indicates that the remainder of a division of the cell identifier of the cell #j by the value m is k. In addition, P represents transmission power of the cell #j and d_{i,j} represents a distance from an RU 220 in the cell #i to an RU 220 in the cell #j. Furthermore, θ is a predetermined attenuation coefficient that is set beforehand according to a wireless environment. The metric wₘ(i,k) expressed by Equation (1) is calculated for each remainder k of a division of a cell identifier PCIⱼ of the cell #j by the value m, the cell identifier PCIⱼ having been set already, and Equation (1) indicates that the smaller the metric wₘ(i,k) is, the smaller the interference from the cell #j corresponding to the remainder k to the cell #i becomes. Therefore, making the cell identifier of the cell #i a cell identifier corresponding to a remainder k that decreases the metric wₘ(i,k) reduces the number of cells in the vicinity of the cell #i, the cells having cell identifiers that leave the same remainder as the remainder k of a division of the cell identifier by the value m.

To calculate metrics for the first value and the second value, the base remainder determining unit 122 calculates a metric w₃(i,k) and a metric w₄(i,k) for each remainder k. The base remainder determining unit 122 then determines base remainders that are the remainders k that respectively minimize the metric w₃(i,k) and the metric w₄(i,k). That is, the base remainder determining unit 122 determines a base remainder K_{i,3} related to the first value, the base remainder K_{i,3} being the remainder k that minimizes the metric w₃(i,k), and determines a base remainder K_{i,4} related to the second value, the base remainder K_{i,4} being the remainder k that minimizes the metric w₄ (i,k). In other words, the base remainder determining unit 122 determines the base remainders K_{i,3} and K_{i,4} for determination related to the cell #i by Equations (2) and (3) below.

$${K}_{i , 3} = {arg min}_{k = \{ 0 , 1 , 2 \}} ( {w}_{3} ( i , k ) ) \qquad ( 2 )$$

$${K}_{i , 4} = {arg min}_{k = \{ 0 , 1 , 2 , 3 \}} ( {w}_{4} ( i , k ) ) \qquad ( 3 )$$

In Equation (2) and (3) above, argmin(x) is a function that returns a value minimizing x.

The LCM remainder determining unit 123 determines the remainder (hereinafter, referred to as the “LCM remainder”) obtained by remainder calculation using the least common multiple of the first value (3, herein), the second value (4, herein), and the third value (30, herein), the remainder corresponding to a cell identifier to be determined. Specifically, the LCM remainder determining unit 123 calculates an LCM remainder obtained by remainder calculation using the least common multiple of the first and second values first, and then determines, by using the LCM remainder calculated, an LCM remainder obtained by remainder calculation using the least common multiple of the first to third values. That is, by using Equation (4) below, the LCM remainder determining unit 123 calculates an LCM remainder K_{i,12} corresponding to 12 that is the least common multiple of 3 and 4, by using the base remainders K_{i,3} and K_{i,4} corresponding to 3 and 4.

K_{i,12}=(4K_{i,3}−3K_{i,4}+12)%12 (4)

By using the LCM remainder K_{i,12}, the LCM remainder determining unit 123 then determines, by Equation (5) below, an LCM remainder K_{i,60} corresponding to 60 that is the least common multiple of 3, 4, and 30. That is, the LCM remainder determining unit 123 determines the LCM remainder K_{i,60} that is a value k minimizing a metric w₃₀(i,k %30) related to the third value, the value k being from values k satisfying the LCM remainder K_{i,12}.

$${K}_{i , 60} = {arg min}_{{k = \{ 0 , … , 59 \}}_{k \%12 = {K}_{i , 12}}} ( {w}_{30} ( i , k \%30 ) ) \qquad ( 5 )$$

On the basis of the LCM remainder related to the least common multiple of the first to third values, the cell identifier determining unit 124 determines a cell identifier of the cell 220a that is a determination target. Specifically, on the basis of the LCM remainder K_{i,60}, the cell identifier determining unit 124 determines a cell identifier PCIᵢ of the cell #i as follows. That is, the cell identifier determining unit 124 determines, as the PCIᵢ of the cell a value satisfying the LCM remainder K_{i,60}.

$${PCI}_{i} = \{ \begin{matrix}60 \cdot R ( 0 , 15 ) + {K}_{i , 60} & ( {K}_{i , 60} \geq 48 ) \\ 60 \cdot R ( 0 , 16 ) + {K}_{i , 60} & ( {K}_{i , 60} < 48 )\end{matrix}$$

In the above equation, R(0,x) represents a random integer from 0 to x. The cell identifier determining unit 124 determines the cell identifier PCIᵢ not exceeding 1008 by conditional branching according to the magnitude of the LCM remainder K_{i,60}. The cell identifier determining unit 124 then generates cell identifier information indicating the determined cell identifier PCIᵢ of the cell #i and causes the cell identifier information to be transmitted from the communication IF unit 110 to the CU/DU 210.

The memory 130 includes, for example, a random access memory (RAM) or a read only memory (ROM) and stores therein information used in processing by the processor 120.

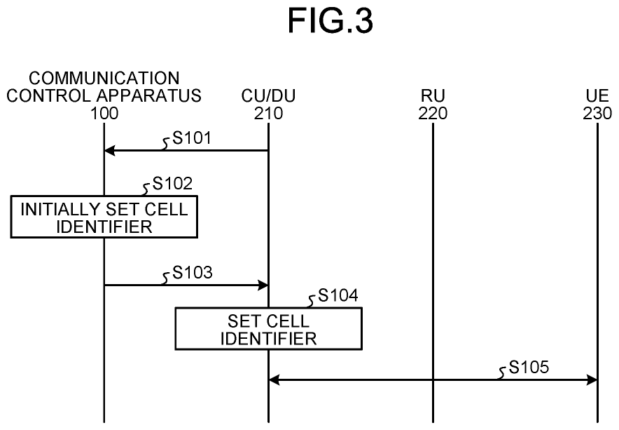

A cell identifier initial setting method in the communication system configured as described above will be described next while reference is made to a sequence diagram illustrated in FIG. 3. This cell identifier initial setting method is, for example, a method of initially setting a cell identifier for a new cell 220a in a case where an RU 220 connected to the CU/DU 210 is newly established and this RU 220 forms the new cell 220a.

The CU/DU 210 transmits cell information on cells 220a including the new cell 220a, to the communication control apparatus 100 (Step S101). This cell information includes positional information on the RUs 220 and transmission power information on the RUs 220. The cell information is obtained by the cell information obtaining unit 121 and initial setting of a cell identifier of the new cell 220a is performed by the base remainder determining unit 122, the LCM remainder determining unit 123, and the cell identifier determining unit 124 (Step S102).

That is, by the base remainder determining unit 122 using the positional information and transmission power information on the RUs 220, metrics expressed by Equation (1) above are calculated and base remainders minimizing the metrics for the first value and the second value are determined as expressed by Equations (2) and (3) above. On the basis of the base remainders, an LCM remainder corresponding to the least common multiple of the first to third values is determined by the LCM remainder determining unit 123 using Equations (4) and (5) above. Furthermore, on the basis of the LCM remainder, the cell identifier of the new cell 220a is determined by the cell identifier determining unit 124.

Information on the cell identifier determined is transmitted from the communication IF unit 110 to the CU/DU 210 (Step S103). The cell identifier of the RU 220 newly established is set by the CU/DU 210 (Step S104), the cell identifier is transmitted by the RU 220 through, for example, a notification channel, and communication is thereby started between the CU/DU 210, the RU 220, and a piece of UE 230 (Step S105).

As described above, in a case where a new cell 220a is formed, an optimum cell identifier in consideration of plural indices is able to be set automatically for the new cell 220a.

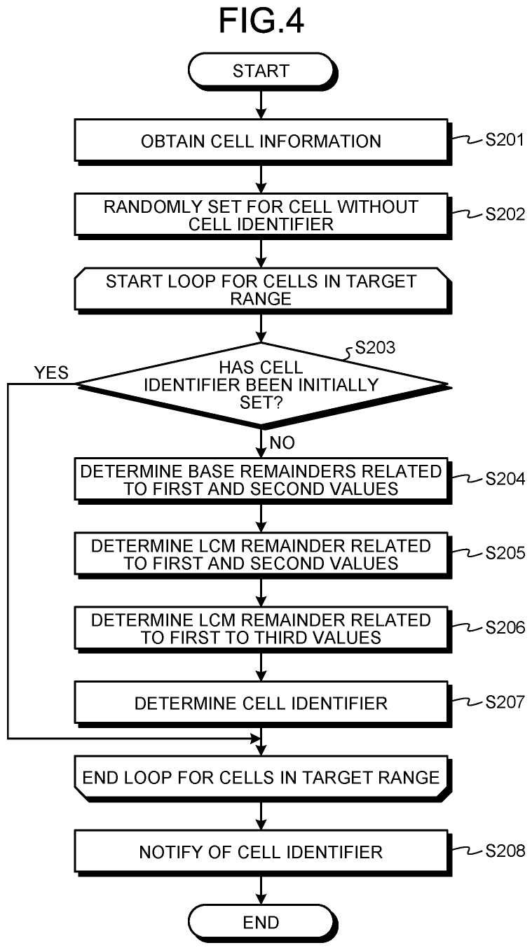

Cell identifier initial setting processing at the communication control apparatus 100 will be described next while reference is made to a flow diagram illustrated in FIG. 4. This cell identifier initial setting processing is mainly executed by the base remainder determining unit 122, the LCM remainder determining unit 123, and the cell identifier determining unit 124.

In response to cell information being obtained by the cell information obtaining unit 121 (Step S201), a cell identifier is randomly set for a cell 220a to which a cell identifier has not been assigned yet (Step S202). That is, for reasons of expediency, a cell identifier is randomly set for a cell 220a formed by an RU 220 that has been newly established, for example. The following processing is then repeated for a set C_{update} of cells 220a in a target range including the cell 220a, for which a cell identifier is to be initially set.

That is, whether or not a cell identifier has been initially set for the cell 220a is determined (Step S203). In this determination, whether or not a cell identifier other than the cell identifier that was randomly set has been assigned to the cell 220a is determined. In a case where a cell identifier has been initially set already (Step S203: Yes), similar determination is repeated for another cell 220a included in the set C_{update}.

In a case where a cell identifier has not been initially set for the cell 220a (Step S203: No), the base remainder determining unit 122 determines base remainders related to the first value and the second value (Step S204). Specifically, for the first value, 3, and the second value, 4, a metric w₃(i,k) and a metric w₄(i,k) are calculated for each remainder k by Equation (1) above, and base remainders K_{i,3} and K_{i,4} that respectively minimize the metrics w₃(i,k) and w₄(i,k) are determined.

An LCM remainder corresponding to the least common multiple of the first value and second value is then determined by the LCM remainder determining unit 123 (Step S205). Specifically, for the least common multiple, 12, of the first value and second value, an LCM remainder K_{i,12} is determined by Equation (4) using the base remainders K_{i,3} and K_{i,4}. Furthermore, an LCM remainder corresponding to the least common multiple of the first value, second value, and third value is then determined by the LCM remainder determining unit 123 (Step S206). Specifically, for the least common multiple, 60, of the first value, second value, and third value, an LCM remainder K_{i,60} is determined by Equation (5) above using the LCM remainder K_{i,12}.

In response to the LCM remainder K_{i,60} being determined, a cell identifier based on the LCM remainder K_{i,60} is determined by the cell identifier determining unit 124 (Step S207). That is, a value that leaves the LCM remainder K_{i,60} as the remainder of a division of the value by the least common multiple, 60, of the first to third values is determined as the cell identifier of the cell 220a. Because this cell identifier is a cell identifier that minimizes the metric related to the first to third values, the number of cells having cell identifiers that leave the same remainders as the remainders of divisions of the cell identifiers by the first to third values is small in the vicinity of the cell 220a.

The initial setting of a cell identifier described above is repeated for the cells 220a included in the set C_{update}, and in response to completion of the initial setting of cell identifiers for all of the cells 220a, cell identifier information is transmitted from the communication IF unit 110 to the CU/DU 210 (Step S208).

As described above, according to the first embodiment, in a case where the remainders obtained by remainder calculation using three values are used as plural indices for determination of a cell identifier, base remainders are determined using metrics corresponding to these values, and an LCM remainder related to the least common multiple of these values is determined on the basis of these base remainders. The cell identifier is then determined using the LCM remainder. Therefore, in initial setting of a cell identifier, an optimum cell identifier in consideration of plural indices is able to be set automatically.

### [b] Second Embodiment

In a second embodiment, a cell identifier is updated to be optimized during operation of a communication system.

A configurations of the communication system according to the second embodiment is similar to that of the first embodiment (FIG. 1) and description thereof will thus be omitted.

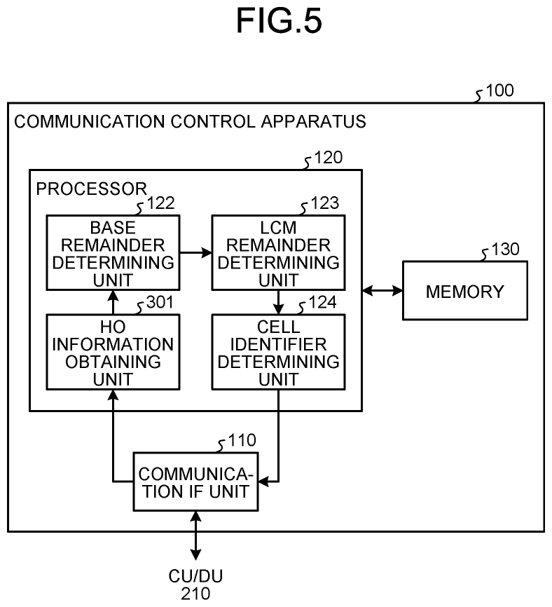

FIG. 5 is a block diagram illustrating a configuration of a communication control apparatus 100 according to the second embodiment. In FIG. 5, the same reference signs are assigned to components that are the same as those in FIG. 2 and description thereof will thus be omitted. The communication control apparatus 100 illustrated in FIG. 5 has a handover information (hereinafter, abbreviated as “HO information”) obtaining unit 301 instead of the cell information obtaining unit 121 illustrated in FIG. 2.

The HO information obtaining unit 301 obtains HO information related to handover between cells 220a by pieces of UE 230, from the communication IF unit 110. In this second embodiment, the CU/DU 210 monitors the handover by the pieces of UE 230 between the cells 220a formed by the respective RUs 220 and counts the numbers of handovers between the cells 220a. The CU/DU 210 then transmits the HO information including information on the counted numbers of handovers, to the communication control apparatus 100. The HO information obtaining unit 301 thus obtains the HO information transmitted by the CU/DU 210. The HO information has, stored therein, the number of times handover has been carried out by the pieces of UE 230, in association with each combination of the cell 220a at the handover source and the cell 220a at the handover destination.

In this second embodiment, because HO information is obtained during operation of the communication system, the base remainder determining unit 122 calculates metrics using the numbers of handovers and determines base remainders that minimize the metrics respectively related to a first value and a second value. Specifically, the base remainder determining unit 122 calculates, by Equation (6) below, a metric wₘ(i,k) for each remainder k obtained by remainder calculation using a value m in determination of a cell identifier of a cell #i.

$${w}_{m} ( i , k ) = {\sum }_{{j ∈ {C}_{update}}_{{PCI}_{j} \% m = k}} ( {N}_{HO , i , j} + {N}_{HO , j , i} ) + {\sum }_{{j ∈ {C}_{outside}}_{{PCI}_{j} \% m = k}} ( {N}_{HO , i , j} + {N}_{HO , j , i} ) \qquad ( 6 )$$

In Equation (6) above, C_{update} represents a set of cells 220a in a target range for which cell identifiers are to be set, and C_{outside} represents a set of cells where handover to and from the cells 220a in the set C_{update} is able to be carried out by pieces of UE 230. Furthermore, PCIⱼ is a cell identifier of a cell #j and % is an operation symbol representing remainder calculation. Therefore, PCIⱼ% m=k indicates that the remainder of a division of the cell identifier of the cell #j by the value m is k. In addition, N_{HO,i,j} represents the number of handovers from the cell #i to the cell #j, and N_{HO,i,j} represents the number of handovers from the cell #j to the cell #i. The metric wₘ(i,k) expressed by Equation (6) is calculated for each remainder k of a division of the cell identifier PCIⱼ of the cell #j by the value m, and Equation (6) indicates that the smaller the metric wₘ(i,k) is, the smaller the number of handovers between the cell #j and the cell #i corresponding to the remainder k is. Therefore, assigning a cell identifier corresponding to the remainder k that minimizes the metric wₘ(i,k) to the cell #i reduces the possibility that handover by pieces of UE 230 occurs between cells 220a having cell identifiers that leave the same remainder k as the remainders of divisions of the cell identifiers by the value m.

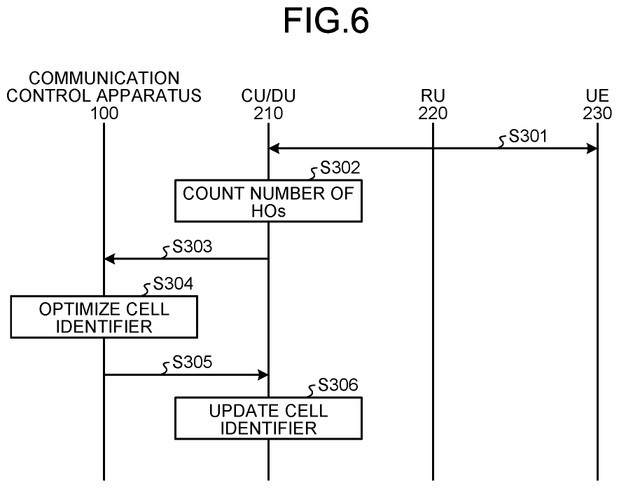

A cell identifier optimization method in the communication system configured as described above will be described next while reference is made to a sequence diagram illustrated in FIG. 6. This cell identifier optimization method is a method of optimizing cell identifiers assigned to cells 220a during operation of the communication system where the cell identifiers have been assigned to all of the cells 220a already.

During the operation of the communication system, communication is executed between the CU/DU 210, the RUs 220, and pieces of UE 230 (Step S301). During the operation, the CU/DU 210 monitors handover by the pieces of UE 230 and counts the numbers of handovers between cells 220a (Step S302). That is, the CU/DU 210 counts the number of handovers by pieces of UE 230 for each combination of a cell 220a at the handover source and a cell 220a at the handover destination. The CU/DU 210 then transmits HO information including a result of the counting of the numbers of handovers, to the communication control apparatus 100 (Step S303).

The HO information is then obtained by the HO information obtaining unit 301 and optimization of the cell identifiers of the cells 220a is performed by the base remainder determining unit 122, the LCM remainder determining unit 123, and the cell identifier determining unit 124 (Step S304). That is, by the base remainder determining unit 122 using the numbers of handovers, metrics according to Equation (6) are calculated and base remainders that minimize the metrics for the first value and second value are determined as expressed by Equations (2) and (3) above. On the basis of the base remainders, an LCM remainder corresponding to the least common multiple of the first to third values is determined by the LCM remainder determining unit 123 using Equations (4) and (5) above. Furthermore, on the basis of the LCM remainder, a cell identifier of a cell 220a is determined by the cell identifier determining unit 124.

Information on the cell identifier determined is transmitted from the communication IF unit 110 to the CU/DU 210 (Step S305). The cell identifier of the cell 220a formed by each RU 220 is then updated by the CU/DU 210 (Step S306).

As described above, in a case where cell identifiers of cells 220a are to be updated during operation of the communication system, an optimum cell identifier in consideration of plural indices is able to be automatically set for a new cell 220a.

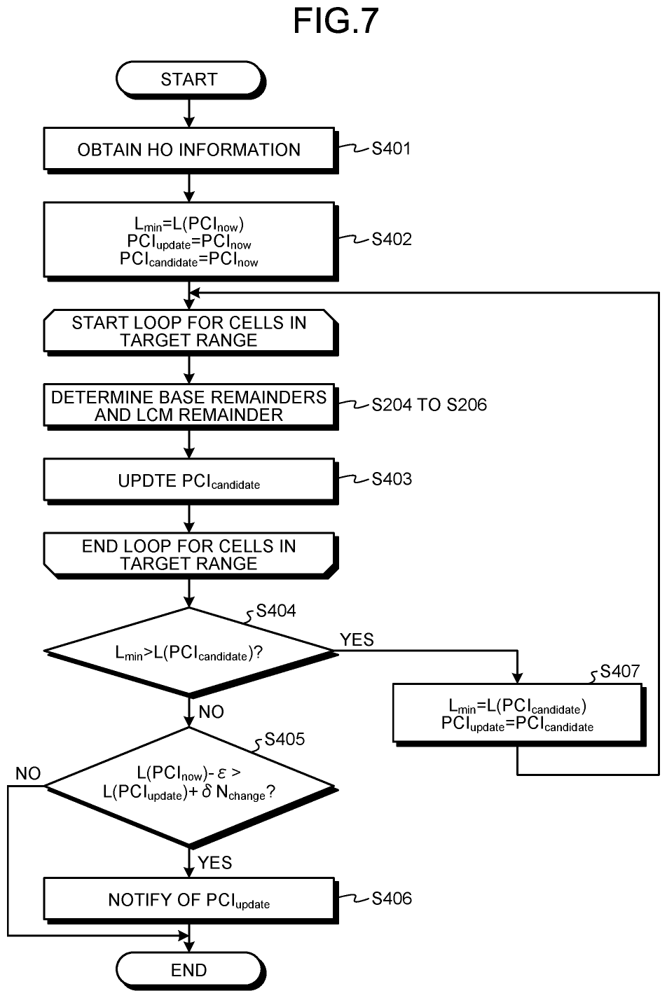

Cell identifier optimization processing at the communication control apparatus 100 will be described next while reference is made to a flow diagram illustrated in FIG. 7. In FIG. 7, the same reference signs are assigned to steps that are the same as those in FIG. 4 and description thereof will thus be omitted. This cell identifier optimization processing is mainly executed by the base remainder determining unit 122, the LCM remainder determining unit 123, and the cell identifier determining unit 124.

In response to HO information being obtained by the HO information obtaining unit 301 (Step S401), parameters for optimization of cell identifiers are initialized (Step S402). Specifically, a minimum value Lₘᵢₙ of an evaluation value L for determination on whether or not a cell identifier of a cell 220a is to be updated is set at an evaluation value L(PCI_{now}) related to a set PCI_{now} of current cell identifiers. Furthermore, a set PCI_{update} of cell identifiers after update and a set PCI_{candidate} of cell identifiers that are update candidates are each initialized to the set PCI_{now} of the current cell identifiers.

The evaluation value L is defined using metrics wₘ(i,k) related to the first value, second value, and third value for a set C_{update} of cells 220a in a target range, as expressed by Equation (7) below.

$$L = α {\sum }_{i ∈ {C}_{update}} {w}_{3} ( i , {PCI}_{i} \%3 ) + β {\sum }_{i ∈ {C}_{update}} {w}_{4} ( i , {PCI}_{i} \%4 ) + γ {\sum }_{i ∈ {C}_{update}} {w}_{30} ( i , {PCI}_{i} \%30 ) \qquad ( 7 )$$

In Equation (7) above, α, β, and γ are weight coefficients related to the first value, second value, and third value, respectively. Therefore, the evaluation value L results from weighted addition of sums of metrics wₘ(i,k) respectively related to the first value, second value, and third value. It can be said that the smaller this evaluation value L is, the more desirable the cell identifiers assigned to the set C_{update} of cells 220a in the target range are in view of plural indices.

In response to initialization of the parameters, the following processing is repeated for the set C_{update} of the cells 220a in the target range for which the cell identifiers are to be optimized.

That is, base remainders related to the first value and second value are determined by the base remainder determining unit 122 (Step S204). An LCM remainder corresponding to the least common multiple of the first value and second value is then determined by the LCM remainder determining unit 123 (Step S205). Furthermore, an LCM remainder corresponding to the least common multiple of the first value, second value, and third value is determined by the LCM remainder determining unit 123 (Step S206).

In response to an LCM remainder K_{i,60} being determined, a cell identifier based on the LCM remainder K_{i,60} is determined by the cell identifier determining unit 124 and the set PCI_{candidate} of update candidates is updated (Step S403). That is, a value that leaves the LCM remainder K_{i,60} as the remainder of a division of the value by the least common multiple, 60, of the first to third values is determined as the cell identifier of the cell 220a and the set PCI_{candidate} of update candidates is updated to include this cell identifier.

This determination of a cell identifier is repeated for the cells 220a included in the set C_{update}, and in response to update of the set PCI_{candidate} of update candidates, an evaluation value L(PCI_{candidate}) related to the set PCI_{candidate} of update candidates is calculated and whether or not the evaluation value L(PCI_{candidate}) calculated is smaller than the evaluation value Lₘᵢₙ is determined (Step S404). In a case where the evaluation value L(PCI_{candidate}) is determined to be smaller than the evaluation value Lₘᵢₙ (Step S404: Yes), the evaluation value L is potentially able to be decreased further, the minimum evaluation value Lₘᵢₙ is thus set as the evaluation value L(PCI_{candidate}) related to the set PCI_{candidate} of update candidates, and the set PCI_{update} of cell identifiers after the update is set as the set PCI_{candidate} of update candidates (Step S407). Thereafter, the processing of updating the set PCI_{candidate} of update candidates for the set C_{update} of cells 220a in the target range is repeated again.

On the contrary, in a case where the evaluation value L(PCI_{candidate}) is determined to be equal to or larger than the evaluation value Lₘᵢₙ at Step S404 (Step S404: No), the set PCI_{update} of cell identifiers after the update is determined because the evaluation value L has become sufficiently small. By use of the evaluation value L, whether or not the cell identifiers of the cells 220a are to be actually updated is determined (Step S405).

Specifically, whether or not the evaluation value L(PCI_{update}) related to the set PCI_{update} of cell identifiers after the update is less than the evaluation value L(PCI_{now}) related to the set PCI_{now} of the current cell identifiers before the update is determined. Changing the cell identifiers places a load on the communication system and a value obtained by weighting, with a predetermined value δ, of the number N_{change} of cells 220a for which the cell identifiers are to be changed by the update to the set PCI_{update} is thus added to the evaluation value L(PCI_{update}). Furthermore, a predetermined value ε is subtracted from the evaluation value L(PCI_{now}). As a result, in a case where the evaluation value L is largely improved, the cell identifiers of the cells 220a are actually updated.

In a case where the evaluation value L(PCI_{update}) is determined not to be largely improved from the evaluation value L(PCI_{now}) at Step S405 (Step S405: No), the update of the cell identifiers of the cells 220a to the set PCI_{update} is cancelled and the CU/DU 210 will not be notified of the set PCI_{update} On the contrary, in a case where the evaluation value L(PCI_{update}) is determined to be largely improved from the evaluation value L(PCI_{now}) (Step S405: Yes), the CU/DU 210 is notified of the set PCI_{update} (Step S406) and the cell identifiers of the cells 220a are actually updated.

As described above, according to the second embodiment, in a case where the remainders obtained by remainder calculation using three values are used as plural indices for determination of a cell identifier, base remainders are determined using metrics corresponding to these values, and an LCM remainder related to the least common multiple of these values is determined on the basis of the base remainders. The cell identifier is then determined using the LCM remainder, and in a case where the evaluation value is improved by the cell identifier determined, update of cell identifiers is executed. Therefore, in optimizing a cell identifier during operation of the communication system, an optimum cell identifier in consideration of plural indices is able to be set automatically.

In the above described second embodiment, metrics wₘ(i,k) are calculated using the numbers of handovers by pieces of UE 230, but a metric wₘ(i,k) may be calculated using the number of pieces of UE 230 near the boundary of a cell 220a, for example. In this case, the base remainder determining unit 122 calculates, by Equation (8) below, a metric wₘ(i,k) for each remainder k obtained by remainder calculation using a value m, in determination of a cell identifier of a cell #i.

$${w}_{m} ( i , k ) = {\sum }_{{j ∈ {C}_{update}}_{{PCI}_{j} \% m = k}} ( {N}_{Edge , i , j} + {N}_{Edge , j , i} ) + {{\sum }_{j ∈ {C}_{outside}}}_{{PCI}_{j} \% m = k} ( {N}_{Edge , i , j} + {N}_{Edge , j , i} ) \qquad ( 8 )$$

In Equation (8) above, N_{Edge,i,j} represents the number of pieces of UE 230 positioned in the cell #1 and near the boundary between the cell #i and the cell #j, and N_{Edge,j,i} represents the number of pieces of UE 230 positioned in the cell #j and near the boundary between the cell #j and the cell #i. The metric wₘ(i,k) expressed by Equation (8) is calculated for each remainder k of a division of the cell identifier PCIᵢ of the cell #j by the value m, and indicates that the smaller the wₘ(i,k) is, the smaller the number of pieces of UE 230 near the boundary between the cell #j and the cell #i corresponding to the remainder k is. Therefore, making the cell identifier of the cell #i a cell identifier corresponding to the remainder k that decreases the metric wₘ(i,k) decreases the possibility that handover is carried out by a piece of UE 230 between cells 220a having cell identifiers that leave the same remainder k as the remainders of divisions of the cell identifiers by the value m.

The number of pieces of UE 230 near the boundary between cells 220a formed by two RUs 220 is able to be counted by determining that a piece of UE 230 is near the boundary between the cells 220a in a case where a difference between amounts of power (for example, reference signal received power (RSRP)) received by the piece of UE 230 from the two RUs 220 is less than a predetermined threshold.

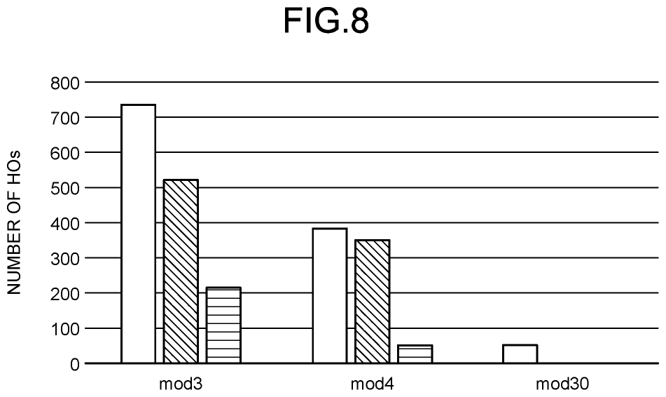

The above described first and second embodiments may be implemented in combination with each other. That is, in a case where a communication system is used by initial setting of cell identifiers like in the first embodiment described above, the cell identifiers may be periodically optimized like in the second embodiment described above. FIG. 8 is a diagram illustrating differences between effects in a case where only the initial setting according to the first embodiment is implemented and effects in a case where the optimization according to the second embodiment is implemented. That is, FIG. 8 illustrates the number of handovers carried out by pieces of UE 230 between cells 220a having cell identifiers that leave the same remainders as the remainders of divisions of the cell identifiers by the first value (that is, 3), the second value (that is, 4), and the third value (that is, 30).

In FIG. 8, white bars represents the numbers of handovers in a case where the cell identifiers are set randomly, bars hatched with oblique lines represent the numbers of handovers in a case where only the initial setting according to the first embodiment is implemented, and bars hatched with horizontal lines represent the numbers of handovers in a case where the optimization according to the second embodiment is implemented. As illustrated in FIG. 8, the numbers of handovers that occur between cells 220a having cell identifiers that leave the same remainders as the remainders of the divisions of the cell identifiers by the first value (that is, 3) and the second value (that is, 4) (“mod3” and “mod4” in FIG. 8) are decreased by implementation of the initial setting according to the first embodiment and are even more largely decreased by implementation of the optimization according to the second embodiment. Furthermore, FIG. 8 illustrates that the number of handovers that occur between cells 220a having cell identifiers that leave the same remainder as the remainders of divisions of the cell identifiers by the third value (that is, 30) becomes 0.

As described above, determining cell identifiers like in the first embodiment and/or second embodiment described above enables automatic setting of optimum cell identifiers in view of plural indices in terms of the remainders of divisions of the cell identifiers by the first value to the third value.

According to an embodiment of a communication control apparatus and an identifier determination method disclosed by the present application, optimum cell identifiers in consideration of plural indices are able to be set automatically.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A communication control apparatus comprising:
a memory; and
a processor coupled to the memory and the processor configured to:
determine, by using metrics related to a first value and a second value, first remainders of divisions of a cell identifier respectively by the first value and the second value;
determine a second remainder of a division of the cell identifier by the least common multiple of the first value and second value, by using the first remainders;
determine a third remainder of a division of the cell identifier by the least common multiple of the first value, the second value, and a third value, by using the second remainder and a metric related to the third value; and
determine a cell identifier that satisfies the third remainder.

2. The communication control apparatus according to claim 1, wherein
the processor is further configured to obtain positional information and transmission power information on a wireless device forming a cell, and
the metrics are calculated based on the positional information and the transmission power information.

3. The communication control apparatus according to claim 1, wherein
the processor is further configured to obtain handover information indicating a number of handovers carried out by a terminal device between cells, and
the metrics are calculated based on the handover information.

4. The communication control apparatus according to claim 1, wherein the processor is further configured to determine values that minimize the metrics as the first remainders, respectively for the first value and the second value.

5. The communication control apparatus according to claim 1, wherein the processor is further configured to determine value that minimizes the metric related to the third value as the third remainder, the value being from values satisfying the second remainder.

6. The communication control apparatus according to claim 1, wherein the processor is further configured to identify a value obtained by adding the third remainder to a multiple of the least common multiple of the first value, second value, and third value as the cell identifier.

7. The communication control apparatus according to claim 1, wherein the processor is further configured to
compare evaluation values before and after change of a cell identifier to the cell identifier that has been determined, the evaluation values each corresponding to the sum of metrics related respectively to the first value, the second value, and the third value, and
in a case where the evaluation value after the change of the cell identifier is improved, execute update to the cell identifier that has been determined.

8. The communication control apparatus according to claim 7, wherein the processor is further configured to
compare a value obtained by subtracting a predetermined value from the evaluation value before the change of the cell identifier and the evaluation value after the change of the cell identifier, and
update the cell identifier in a case where the evaluation value after the change of the cell identifier is smaller than the value as a result of the comparison.

9. The communication control apparatus according to claim 7, wherein the processor is further configured to
compare the evaluation value before the change of the cell identifier and an added value obtained by adding a value to the evaluation value after the change of the cell identifier, the value corresponding to the number of cells having cell identifiers to be changed, and
update the cell identifier in a case where the added value is smaller than the evaluation value before the change of the cell identifier as a result of the comparison.

10. An identifier determination method of determining a cell identifier of a cell used in wireless communication, the identifier determination method comprising:
determining, by using metrics related to a first value and a second value, first remainders of divisions of a cell identifier respectively by the first value and the second value;
determining a second remainder of a division of the cell identifier by the least common multiple of the first value and second value, by using the first remainders;
determining a third remainder of a division of the cell identifier by the least common multiple of the first value, the second value, and a third value, by using the second remainder and a metric related to the third value; and
determining a cell identifier that satisfies the third remainder, using a processor.
